(19) United States
(12) Patent Application Publication
(10) Pub. No.: US 2010/0156600 A1
(43) Pub. Date: Jun. 24, 2010

(54) Method and System for a Broadband Impedance Compensated Slot Antenna (BICSA)

(76) Inventors: Mark Duron, Bayport, NY (US); Richard Knadle, Dix Hills, NY (US)

Correspondence Address: MOTOROLA, INC., 1303 EAST ALGONQUIN ROAD, IL01/3RD, SCHAUMBURG, IL, 60196, US

(21) Appl. No.: 12/339,442

(22) Filed: Dec. 19, 2008

(51) Int. Cl. H04Q 5/22; H01Q 1/50

(52) U.S. Cl. 340/10.1; 343/861

(57) ABSTRACT

Described herein are devices, systems and methods for compensating a frequency response of an antenna to an electronic device, such as a radio frequency identification (“RFID”) reader. An exemplary embodiment is a device including at least one radio frequency (“RF”) source for transmitting RF signals, at least one RF receiver for receiving RF signals, an antenna in simultaneous communication with the RF source and the RF receiver, and at least one distributed RF compensator network controlling an operating RF between the antenna and the communication device, wherein the at least one distributed RF compensator creates a particular antenna impedance that operates with a directional coupler and increases an RF isolation between the RF source and the RF receiver across a particular frequency region. An further exemplary embodiment is a method including determining a frequency response impedance measurement of an antenna of a communication device, the communication device including a compensator network attached to the antenna, and adjusting at least one operating setting of the compensator network to create a antenna impedance, wherein the antenna impedance improves an isolation between a transmitting function and a receiving function of the communication device.

### FIELD OF INVENTION

The present application generally relates to systems and methods for compensating a frequency response of an antenna to an electronic device, such as a radio frequency identification (“RFID”) reader.

### BACKGROUND

RFID technology includes systems and methods for non-contact reading of targets (e.g., products, people, vehicles, livestock, etc.) in order to facilitate effective management of these targets within a business enterprise. Specifically, RFID technology allows for the automatic identification of targets, storing target location data, and remotely retrieving target data through the use of RFID tags, or transponders. The RFID tags are an improvement over standard bar codes since the tags may have read and write capabilities, as well as being able to provide more stored data (e.g., 96 bits instead of the 14 bits stored within typical bar codes). Accordingly, the target data stored on RFID tags can be changed, updated and/or locked. Due to the ability to track moving objects, RFID technology has established itself in a wide range of markets including retail inventory tracking, manufacturing production chains, and automated vehicle identification systems. For example, through the use of RFID tags, a retail store can see how quickly the products leave the shelves, and gather information on the customer buying the product.

Within an RFID system, the RFID tag may be a device that is either applied directly to, or incorporated into, one or more targets for the purpose of identification via radio signals. A typical RFID tag may contain at least two parts. A first part is an integrated circuit for storing and processing information, as well as for modulating and demodulating a radio signal. A second part is an antenna for receiving and transmitting radio signals including target data. A typical RFID reader may contain a radio transceiver and may be capable of receiving and processing these radio signals from several meters away and beyond the line of sight of the tag.

### SUMMARY OF THE INVENTION

The present invention is generally related to devices, systems and methods for compensating a frequency response of an antenna to an electronic device, such as a radio frequency identification (“RFID”) reader. One exemplary embodiment is related to a communication device including at least one radio frequency (“RF”) source for transmitting RF signals, at least one RF receiver for receiving RF signals, an antenna in simultaneous communication with the RF source and the RF receiver, and at least one distributed RF compensator network controlling an operating RF between the antenna and the communication device, wherein the at least one distributed RF compensator creates a particular antenna impedance that operates with a directional coupler and increases an RF isolation between the RF source and the RF receiver across a particular frequency region.

A further exemplary embodiment is related to a method including determining a frequency response impedance measurement of an antenna of a communication device, the communication device including a compensator network attached to the antenna, and adjusting at least one operating setting of the compensator network to create a antenna impedance, wherein the antenna impedance improves an isolation between a transmitting function and a receiving function of the communication device

A further exemplary embodiment is related to a system including a measuring means for determining a frequency response impedance measurement of an antenna of a communication device, the communication device including a compensator network attached to the antenna, and a compensating means for adjusting at least one operating setting of the compensator network to create a antenna impedance, wherein the antenna impedance improves an isolation between a transmitting function and a receiving function of the communication device.

### BRIEF DESCRIPTION OF THE DRAWINGS

FIG. 1A shows an exemplary embodiment of an electronic device, such as a handheld mobile RFID reader, according to the present invention.

FIG. 1B shows a detailed illustration for the broadband impedance compensated slot antenna of an RFID radio according to the present invention.

FIG. 2 represents an exemplary method for compensating a frequency response of an antenna of an electronic device, such as the RFID reader according to the exemplary embodiments of the present invention.

### DETAILED DESCRIPTION

The exemplary embodiments of the present invention may be further understood with reference to the following description of exemplary embodiments and the related appended drawings, wherein like elements are provided with the same reference numerals. The present invention generally relates to systems and methods for compensating the frequency response of an antenna to an electronic device, such as a radio frequency identification (“RFID”) reader. Specifically, the exemplary system and methods may be used in conjunction with a slot dipole antenna in order to allow for greater bandwidth and small implemented size.

Under ordinary conditions, an antenna may be declared to be operational over a particular frequency range if, within that range, it displays an input impedance Voltage Standing Wave Ratio (“VSWR”) that does not exceed a ratio of 2:1, wherein this ratio equates to a Voltage Reflection Coefficient (“S11”) of −9.5 dB or less. Therefore, these parameters correspond to a transmission efficiency of 89%. However, it should be noted that an application requiring a higher level of performance may require an antenna with a VSWR of less than 1.5:1, wherein this ratio equates to an S11 of −14 dB, and corresponds to a transmission efficiency of 96%.

One skilled in the art would understand that many RFID transmitters produce one watt of power output (+30 dBm, the FCC specification maximum). However, conventional RFID reader receivers become non-linear when a received signal amplitude approaches the level between −10 dBm (0.1 milliwatt) and 0.0 dBm (one milliwatt). Therefore, an RFID reader that is simultaneously sharing the same antenna for transmitting and receiving, as well as being coupled to the receiver by way of a Directional Coupler (“DC”) that has a −10 dB coupling coefficient, will require that the antenna reflect no more than approximately +10 dBm to 0.0 dBm when excited with a signal of +30 dBm. Accordingly, this may be defined as the origin of the −30 dB S11 voltage reflection coefficient requirement. According to the exemplary embodiments of the invention, this S11 voltage reflection coefficient requirement may be a design goal that can optionally be allowed to degrade to −20 dB of S11.

Typical RFID reader antennas of a conventional design can be modeled as a resonator with a single pole. A half-wavelength long dipole antenna in free space, which may be analogous to a slot antenna in a conductive sheet, may serve as an example of a single pole resonator that possesses a 2:1 VSWR (e.g., an S11 of −9.5 dB, an efficiency of 89%, and a loss of −0.51 dB). Furthermore, this 2:1 VSER antenna may also feature a bandwidth of approximately 8 to 13 percent, depending on the antenna's diameter-to-length ratio. According to one embodiment of the present invention, a 10% bandwidth may be assumed, however it should be noted that the present invention is not limited to such a bandwidth. To a first-order of approximation, a swept frequency performance may be analogous to a one-pole Butterworth band-pass filter response. Utilizing the filter's voltage transfer function equation will indicate that the −30 dB S11 response may be approximately 3.16% of the −9.5 dB S11 bandwidth, which was 10 for the dipole antenna, or 0.32% when using a one pole model for the antenna.

As described above, a well-matched conventional dipole antenna can only have a −30 dB S11 bandwidth of approximately 0.3 percent. The operating band for a UHF RFID Reader system, for instance, may be between approximately 902 to 928 MHz, a bandwidth that spans 2.8 percent of the center frequency (e.g., 915 MHz). Therefore, a conventional dipole antenna in free space will miss the requirement by more than a 10:1 ratio. Moreover, physical restrictions that exist within the typical package of a hand-held reader may force the antenna designer to considerably decrease the volume that can be devoted to the antenna assembly, which will further decrease the operating bandwidth. According to the exemplary embodiments of the present invention, techniques may be used to increase the bandwidth of operation, thus it will become possible to decrease the antenna size and maintain the VSWR performance.

The conventional techniques that have been used heretofore to broaden the operating bandwidth may include, but are not limited to, simple inductive and capacitive loading, radiator meandering, the use of high dielectric constant materials, etc. However, these conventional techniques may also increase the quality factor Q as predicted by the Chu-Wheeler theory, thus the bandwidth will be decrease further.

Examples of these techniques may include, but are not limited to: (1) using resistive loading and dielectrically lossy loading within the radiating structure; (2) using an attenuator in the feed structure; (3) using multiple de-coupled radiating elements plus a Quadrature Hybrid; (4) using partially-coupled multiple radiator elements that simulate a Chebyshev Filter, for instance; (5) applying an impedance compensating network; and (6) a radiator with a large diameter, or wide, flat, and tapered materials, etc. Each of these techniques may have its disadvantages. Lowering the gain and radiating efficiency will cause a significant portion of the RF energy to be turned into heat (e.g., as in techniques 1, 2, and 3). In addition, techniques 3, 4, 5 and 6 may cause an increase in the required volume. Techniques 3 and 4 may force some of the radiated power to be on a different polarization so as to decouple the multiple radiators. Technique 5 may increase the operating bandwidth of the antenna, but places a limit on the magnitude of the achievable value of S11 over the band of interest with a realizable passive network (e.g., as predicted by the Bode-Fano impedance matching criteria).

One skilled in the art would understand that there be variations in the reader requirements based on the type of reader (e.g., there may be a fixed reader requirement and a hand-held reader requirement). For instances, there are dual-antenna types of fixed-position RFID readers (e.g., bi-static readers) that may function with a pair of conventional antennas. The quality of this function may be maintained as long as there is sufficient isolation between the transmitting antenna function (“Tx”), and the receiving antenna function (“Rx”). In addition, as users are now demanding portable hand-held RFID readers, there may be a hand-held reader requirement. It should be noted that the decrease in available volume that exists in that application forces the use of a single antenna that can accomplish both the RFID transmitting function (Tx) and the RFID receiving function (Rx). These types of antennas may be referred to as “Mono-static Readers”. Accordingly, in a Mono-static Reader application, a desirable antenna S11 may be −30 dB (or less), so as to not cause an overload condition within the receiver portion of the RFID reader.

The Mono-static RFID Reader may only differentiate the transmitted RF signal (Tx) from the received RF signal (Rx) through the use of a High Directivity Directional Coupler (“DC”). This High Directivity DC may be located within a transmission line attached to the Mono-static antenna. It should be noted that since the transmitted frequency and the received frequency are virtually identical, any filtering of the two signals as a method of differentiating the Rx signal from the Tx signal would be ineffective. However, an antenna that does not possess an S11 (i.e., a reflection coefficient) of approximately −30 dB may create a magnitude of Rx signal that is likely to overload the RFID Receiver. Accordingly, this may decrease its sensitivity to the Tag signal, and it may make the RFID Reader vulnerable to the intermodulation distortion effects, which are likely to occur in a “rich-reader environment”.

Typically, a transmission line may be used as an impedance inverter, or as an impedance converter mechanism. Accordingly, the length of the transmission line of a chosen impedance is used to rotate a Smith chart impedance plot (e.g., at a constant radius from the chart center) so as to arrive at a new Smith chart impedance plot location that was more desirable. This assumes that the transmission line are being used in a serial manner. In addition, there is a similar use of a transmission line as a shunting stub to correct a remaining reactance that may be present. However, the technique is quite limited in the frequency range of operation. In these scenarios, an antenna designer is typically seeking an S11 of about −10 to −15 dB, which may be an acceptable amount for normal circuit, or antenna, transmission efficiency. Furthermore, the designer is typically seeking that particular impedance performance over a frequency region that spanned a good fraction of an octave, or more. However, according to an exemplary embodiment of the present invention, the antenna designer may achieve a greater performance from an exemplary transmission line. Specifically, due to the special needs of a Monostatic RFID reader application, the designer may achieve an S11 of −30 dB, as well as an apparent circuit efficiency of 99.9%. Furthermore, the higher performance of the S11 of −30 dB may be achieved over a frequency region of about 3% of an octave. Thus, the S11 performance is nearly two orders of magnitude greater, while over a frequency region that is nearly two orders of magnitude less.

According to an exemplary embodiment of the present invention, an exemplary auxiliary transmission line may be used as an impedance compensator. The transmission line includes, a particular chosen length, a particular chosen impedance, as well as multiple chosen L-C-R networks (e.g., chosen L-C-R networks at each end of the transmission line). The auxiliary transmission line, as well the attached L-C-R networks, may be used as a phase shifting device (e.g., of primarily the reactive impedance component) where the rate of phase shift is equal in [de phi/de F], and complimentary to the rate of phase shift of the antenna to be compensated.

As discussed above, the reactive component of the antenna impedance may change at a much faster rate than the resistive component when the applied frequency deviates from the design center frequency. Thus, it becomes more difficult, if not impossible, to completely accommodate this change (e.g., for an S11 requirement of −30 dB) by using only an L-C-R network for the impedance matching function. The simultaneous use of a transmission line (e.g., a time-delaying device) gives the antenna designer an additional tool to accommodate the rate of impedance change versus frequency. Accordingly, the longer the transmission line may translate to a greater rate of change in phase versus frequency (e.g., the [de phi/de F]).

It should be noted that conventional antenna designers have failed to recognize the exemplary technique since it is utilized for a small frequency region. Because only over that region would the simplistic model of the slot antenna impedance include a single L-C-R network. For a conventional designer to use this technique over the larger fraction of an octave, and for the unusual depth of S11, like −30 dB, the designer would have had to use a more complex slot antenna equivalent L-C-R circuit (e.g., one containing many L-C-R networks), and thus, many simultaneous phase-shifting transmission line impedance compensators, with just the right coupling coefficients between them. This would be a formidable task.

An antenna manufacturer who receives a Request for Quote (“RFQ”) for an antenna with an S11 of −30 dB over the operating bandwidth, corresponding to a VSWR performance of 1.065:1 or better might mistakenly think the customer is requesting a transmitting efficiency of 99.9%, which would be far beyond the point of a diminishing return on investment. Until now, conventional antennas are not manufactured to a tighter specification than 1.15:1 VSWR. One of the reasons for this is the fact that a popular design did not exist that could maintain that performance over the required frequency range. A further reason is that such an endeavor would create a significant impact to the manufacturing yield, and thereby impact the overall cost of the antenna.

It should be noted that there may be significant limitations of applying a lossy network to an antenna. Specifically, a lossy feed line example may demonstrate a limitation of simply applying a lossy network to an operating antenna in this application. For instance, a high performance antenna may have a VSWR of 1.5:1 and an S11 of −14 dB. In order for this antenna to achieve an apparent S11 of −30 dB (i.e., an s11 improvement of 16 dB), 8 dB of attenuation may be added to the transmission line. Accordingly, the presence of the attenuation may lower the radiating efficiency to 16%, assuming that the radiator alone has an efficiency of 100%. Similarly, an antenna having a VSWR of 2:1 and an S11 of −9.5 dB may require an attenuator of 10.25 dB. This attenuation will lower the maximum radiating efficiency to 9.4%. The impact of these inefficiencies is almost intolerable when they are being applied to an RFID reader system.

The reading range of an exemplary RFID reader system may be limited by the equivalent isotropically radiated power (“EIRP”) that the system can deliver. This is due to the fact that a high performance passive RFID Tag may require a forward-propagated signal level of approximately −10 dBm (e.g., measured at the dipole antenna of the Tag) in order for the antenna to supply enough energy to the tag circuitry for it to wake up and respond. Furthermore, the FCC rules allow a maximum EIRP of 4 watts (e.g., with a maximum of +6.0 dB of antenna Gain). If an antenna system of 9.4% radiating efficiency was to be used, this system would require a 42.4 watt signal to be applied to it, in order to achieve the maximum allowable EIRP. For a portable reader system this would be very impractical from the viewpoint of battery consumption and heat dissipation. Similarly, a 16% efficient radiator system would require a 25.2-watt signal to be applied to it.

The use of an attenuation network within a Monostatic antenna system as a means of achieving an improved S11 performance may have a further impact to the performance of the RFID reader. This is because the attenuation may be located either on the antenna side of the directional coupler or within the antenna itself. Once the attenuation is placed, the directional coupler will experience the S11 of −30 dB from the antenna that enables it to deliver the high directivity that is required between the Tx function and the Rx function.

However, it should be noted that the added attenuation will create further limitations. Specifically, the added attenuation will attenuate the signal that is being returned from the RFID tag, thus it will cause a Rx function desensitization that is equal to the attenuation. A well-designed RFID reader system is usually forward-link limited, as apposed to being reverse-link limited. Thus, the receiver system read range will usually not be limited by the first few decibels of transmission line attenuation. Beyond approximately 5 dB of attenuation, for many reader scenarios, the attenuation will have an impact on the RFID read range. Secondly, in order for the RFID reader to achieve the same EIRP so that tags at the same range will be properly illuminated with the forward-link signal, it will be required to increase the transmitter power by an amount (e.g., in decibels) that is equal to the transmission line attenuation (e.g., in decibels). However, the stronger transmitter power will, in turn, require a greater directivity (e.g., isolation) to be present at the directional coupler. Without the greater directivity the Rx function will suffer transmitter signal overload, which will create desensitization and intermodulation distortion within the receiver. Each decibel of transmission line attenuation will lower the antenna S11 by two decibels, but it will require a directivity improvement of one decibel. The net result is that an apparent improvement in the S11 (e.g., in decibels) will require an equal number of decibels to be added to the transmission line, as apposed to one half the number of decibels that was used in the previous simplified antenna S11 assessment.

Accordingly, these additional limitations, plus the battery consumption factor, and the thermal dissipation factor emphasize the importance of achieving the desired Monostatic antenna S11 performance in a lossless manner. The slot antenna compensator approach is primarily a lossless approach that usually requires very little resistive attenuation within the L-C-R portions of the compensator.

In typical RFID systems, there are no conventional compact and portable antenna systems that could achieve the requirements of −30 dB of S11 and high efficiency over a required frequency range. While certain antenna types (e.g., a circular polarized quadrature hybrid fed patch antenna system) may meet the S11 requirement in a repeatable manner, the size and weight of the system are each too large for to a hand-held type of portable reader system.

It should be noted that within dipole-like antenna designs, a reactive portion of their input impedance may change at a much faster rate than the resistive portion does when the applied frequency deviates from the intended center frequency (e.g., the frequency in which the antenna was designed for). In order to achieve an S11 of −30 dB or better while assuming that only the resistive component of the input impedance was in error, the resistive component of a 50-ohm antenna design, for instance, must deviate by less than +3.265 or −3.065 ohms. Assuming that only the reactive component of the input impedance was in error, then that component must be less than plus and minus 3.16385 ohms. In the more general case the antenna input impedance may contain both a resistive and reactive impedance error components when the applied frequency deviates from the design center frequency. For instance, a 50-ohm antenna design that displays an input impedance of (51+j3)-ohms may yield an S11 of −30.1 dB. While a normal dipole or slot antenna may only meet this requirement over a frequency range of 0.3 percent (wherein a 2.8 percent is required).

According to an exemplary embodiment of the present invention, the antenna system may include a broadband impedance compensated slot antenna (“BICSA”). Specifically, the exemplary embodiment of this invention may consist of a conventional slot antenna that is being fed with a simultaneously present auxiliary series coaxial cable structure (e.g., an additional transmission line), of a specific length, that is itself terminated with an RLC network. The auxiliary coaxial cable structure may be used to present a complementary impedance in both the reactive component and the resistive component, so that the total slot antenna presents an input impedance that is essentially unchanging throughout the desired frequency range.

By selecting an appropriate length of the auxiliary transmission line, the designer may have an additional tool that allows control of the rate of change of the reactive component (e.g., change of phase versus change of frequency [de phi/de F]) of the impedance of the compensating network. The goal is have the rate of change within the compensating network match the rate of change within the antenna, and to do so in a conjugate impedance manner. Previously, designers attempted to do the compensation within only an L-C-R network, which did not have enough degrees of freedom to accomplish the −30 dB S11 goal over the required frequency range.

It should be noted that the exemplary auxiliary coaxial transmission line, according to this embodiment, is being used for its impedance transformation properties versus frequency. Furthermore, with the proper re-adjustment of the parameters, a number of different types of transmission lines may be used (e.g., such as, for example, a Strip Line, a Micro Strip, a twin lead, a fin line, a co-planar waveguide, a co-planar waveguide with ground plane, a waveguide, a ridged waveguide, etc.).

A first order approximation of an equivalent circuit of a slot antenna may be a parallel L-C-R resonator that simulates the fundamental resonance of the antenna. For example, a simplified circuit may yield a shunt inductive reactance in its input impedance if the applied frequency is lower than the resonant frequency (e.g., the frequency wherein the reactance is zero). The auxiliary series coaxial structure may be chosen to have a particular length, and it is terminated with the particular L-R-C network. When these two parameters are chosen correctly, the auxiliary coaxial structure may present the desired complimentary impedance. For instance, the auxiliary coaxial structure may at least present the impedance over a particular frequency region. The frequency region may be limited due to the fact that a rigorous analysis of a slot antenna would reveal an equivalent circuit that is more complex than a simple parallel L-C-R equivalent circuit. However, with further analysis of the equivalent circuit of the slot antenna, it will become possible to add additional auxiliary coaxial cable structures so as to accommodate and compensate for the impedance perturbations of the additional components of the more complex equivalent circuit.

Accordingly, the exemplary embodiments of the systems and methods described herein may be implemented on an RFID antenna, such as a slot antenna. An exemplary slot antenna, or BICSA, may include a conductive sheet (e.g., a conductive sheet that is flat, angled, or curved in multiple planes, etc.) that has a resonant slot RF radiator cut into it. The resonant slot RF radiator may have a number of possible shapes that are similar to a dipole, tripole, quadrapole, triangle, loop, oval, cross, Jerusalem cross, etc.). Furthermore, the resonance property of the slot radiator might not be natural. In other words, the impedance matching network or networks plus the compensator network or networks might be required to establish the resonance of the slot RF radiator.

The BICSA may further include a primary transmission line that feeds energy to, or from, the resonant slot. As described above, this transmission line may include one or more of the various types, such as coaxial, triaxial, twin lead, micro strip, strip line, waveguide, elliptical waveguide, co-planar waveguide, co-planar wave guide plus ground plane, fin line, etc. Accordingly, the primary transmission line may convey energy between the BICSA and the attached electronic package.

The BICSA may further include one or more L-C-R networks that act as an impedance matching network at the interface between the primary transmission line and the slot RF radiator. A secondary L-C-R network may be part of the primary compensator network. Specifically, the secondary L-C-R network may be mounted at the terminus of the secondary transmission line.

The BICSA may further include a secondary transmission line of a chosen length that may be part of the primary compensator network. The secondary transmission may bridge the gap between the slot RF radiator and the secondary L-C-R network. Furthermore, the secondary transmission line may consist of one or more of the various types that have been referenced above.

The BICSA may further include multiple secondary impedance compensating networks, similar to the secondary transmission line and the secondary L-C-R network referenced above. Accordingly, the primary compensating network and the secondary compensating network (or networks) may be attached to the slot RF radiator at various locations that may or may not correspond to the attachment location of the primary transmission line.

It should be noted that the conductive sheet of the BICSA may be driven as an antenna by a driving frequency. Once this occurrence, the resonant slot may radiate electromagnetic waves in similar manner to a dipole antenna. The conventional dipole in free space has a duality with a similarly shaped slot antenna that is constructed within a large metallic sheet of material. The dipole and the slot each create the same antenna pattern, with the exception that the corresponding E-field and H-field will be transposed.

It should be noted that the size and shape of the resonant slot, in addition to the driving frequency, may determine a radiation distribution pattern of the BICSA. Accordingly, slot antennas may be used in place of line antennas when greater control of the radiation pattern is required. Furthermore, advantages of slot antennas include its size, design simplicity, robustness, and convenient adaptation to mass production.

There are situations where a useful object is constructed from a sheet of conductive material (e.g., a conductive sheet), wherein the conductive material may be either flat or curved in multiple planes. There are effective ways of creating a slot antenna within that conductive sheet without affecting the mechanical strength of the conductive sheet. To construct a more conventional antenna (e.g., a dipole antenna) within that environment may require the installation of at least one layer of a dielectric material plus an additional conductive layer for the dipole. Accordingly, the thickness of the object will be increased, and the antenna performance may be compromised due to the proximity of the conductive sheet. By comparison, the slot antenna performance will improve as the dimensions of the conductive sheet are increased.

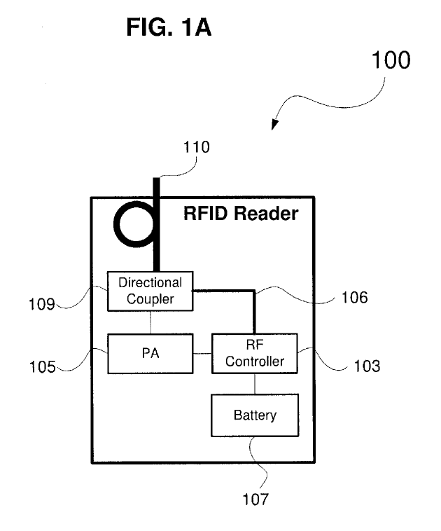

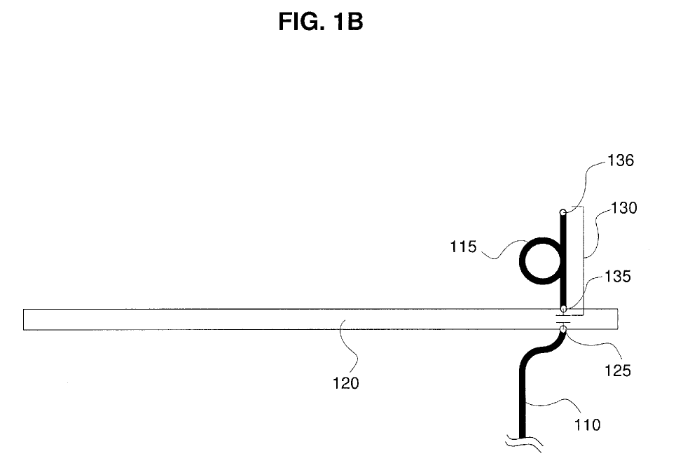

FIG. 1A shows an exemplary embodiment of an electronic device, such as a handheld mobile RFID reader 100, according to the present invention. The RFID reader 100 may include components such as a radio frequency (“RF”) controller 103, a power amplifier (“PA”) 105, a battery 107, and a coiled transmission line 110 that is connected to a radiating slot antenna 120 that becomes the termination of 110. The RF controller 103 includes the RFID receiver, which has an additional transmission line 106 that is tapped into transmission line 110 by way of a directional coupler (“DC”) 109.

According to the exemplary embodiment of the present invention, the coiled transmission line 110 may connect the PA 105 to the slot antenna 120. The looped nature of the coiled transmission line 110 may represent a simplified RF choke that is acting like a Current Balun. Accordingly, a 1:1 Current Balun Transformer (not shown) may also be used at this location. The exemplary Current Balun may impede an RF current that would flow upon the outer conductor of transmission line 110 when a specific type of an unbalanced impedance function exists at the antenna 120. It should be noted that there are other types of Current Baluns that may be used in this location, such as Current Baluns possessing higher common-mode-impedance isolation. One skilled in the art would understand that an antenna designers usually tries to avoid a condition where common-mode current flows on the transmission line 110. This is due to the fact that this condition can cause electromagnetic interference (“EMI”) to occur within circuits that are adjacent to the transmission line 110. Furthermore, the RF signal that could be radiated by the transmission may interfere with the antenna pattern of the designated antenna.

As will be described in greater detail, the exemplary slot antenna 120 may be a broadband impedance compensated slot antenna (“BICSA”) having a reduced size. Accordingly, the RFID reader 100 may include circuitry that actively adjusts the operating settings, such as a frequency response, of the antenna 120. Furthermore, the RF controller 103 may adjust the amount of power at the PA 105 prior to transmitting a data signal from the antenna 120. Accordingly, the RFID reader 100 may dynamically adjust the output power setting prior to initiation any communication with an exemplary RFID tag.

The functions of the RF controller 103 may include managing the output power from the antenna 120 and adjusting the power level of the PA 105. Specifically, the RF controller 103 may regulate the operation of the RFID reader 100 by facilitating communications between the various components. For example, the RF controller 103 may include any one of a microprocessor, an embedded controller, a further application-specific integrated circuit (“ASIC”) chip, a programmable logic array, etc. The RF controller 103 may perform data processing, execute instructions and direct a flow of data between devices coupled to the RF controller 103. As will be explained below, the RF controller 103, according to the exemplary embodiments of the present invention, may be used to compensate the frequency response of the antenna 120 within the RFID reader 100. It can accomplish the compensation by commanding a change to the component values of either of the L-C-R networks that are located at either end of the auxiliary transmission line frequency compensating network or networks. The passive portion of the compensating network will accomplish the major portion of the frequency compensation. The commanded component value change is a kind of “fine tuning” that has the purpose to expand the frequency region over which the desired S11 will be achieved, as the transmitter changes the frequency of the signal being generated. The commanded change in the L-C-R component value(s) can be accomplished (for instance) by way of a varactor diode, transistor, saturate-able reactor, PIN diode, relay switch, command-able resistive network, negative impedance converter, Miller-effect circuit, etc.

It should be noted that the exemplary antenna 120 of the RFID reader 100 may further be described as a cross-polarized antenna, in that it may radiate signals on both a first axis and a second axis. Specifically, the first axis may be substantially orthogonal to the second axis. For instance, when a first signal is applied to a first axis, the antenna 120 may exhibit higher gain along the first axis and lower gain along a second axis responsive to the first signal. Conversely, when a second signal is applied to the second axis, the antenna 120 may exhibit higher gain along the second axis and lower gain along the first axis. In one particular embodiment, when the same signal is applied to both the first axis and the second axis simultaneously, with various amplitude differences or phase differences (that are either fixed or commanded), the antenna 120 may provide: (1) a more omni-directional type gain characteristic since the nulls in the radiation pattern of one axis may be filled by the peaks in the radiation pattern of the other axis, and vice-versa; (2) various radiated signal adaptive polarization characteristics when viewed from certain positions in three dimensional space, such as linear (at various polarization angles), elliptical (with the major axis at various polarization angles), and circular with either polarization sense (such as clockwise or counter-clockwise). In general, an omni-directional antenna may be defined as an antenna that may exhibit substantially equal field strength along one or more axes and/or along one or more planes of the antenna 120.

According to the exemplary embodiments of the present invention, the performance of the RFID reader 100 may increase despite the reduced size for the antenna 120, which is due to the decreased available volume within the RFID reader product. In addition, the exemplary RFID reader 100 may allow the antenna 120 to exhibit greater mechanical integrity. Furthermore, the reduced size may allow for easier packaging of the antenna 120.

FIG. 1B shows a detailed illustration for a broadband impedance compensated slot antenna (BICSA) 120 of an RFID radio according to the present invention. The exemplary antenna 120 will be described with reference to the exemplary RFID reader 100 of FIG. 1A. The coiled transmission line 110 may be connected to the PA 105 of FIG. 1A. This transmission line 110 may serve as the method for exciting the slot antenna 120.

The slot antenna 120 may be an aperture in a conductive material, such as a conductive plate. It should be noted that the conductive plate may serve as a housing for an electronic device, such as the RFID reader 100 or FIG. 1A. The conductive plate may include a reactance 125 (e.g., an L-C-R circuit), wherein the reactance 125 may serve as a coupling structure to the auxiliary transmission line 115. The auxiliary transmission line 115 may be defined as the auxiliary coaxial transmission line coil for presenting a compact package of a particular electrical length in order to achieve a desired impedance transformation versus frequency. In addition, the reactance 125 may be a reactive network that aids in the proper coupling into an impedance-compensating network 130 of the auxiliary transmission line 115.

While FIG. 1B illustrates the reactance 125 as a common reactance between transmission line 110 and transmission line 115, it should be noted that the end of the transmission line 115 at the compensator network 130 may contain additional reactances, such as a separate L-C-R impedance loading network 135 at the beginning of the transmission line 115 and a further L-C-R impedance loading network 136 at the terminus of the transmission line 115. Accordingly, this additional reactance may be primarily reactive, as apposed to resistive.

As described above, the reactance 125 may be described as an L-C-R network that both feeds the slot antenna 120 as well as exciting the auxiliary transmission line 115 that, with the aid of the second L-C-R reactive network, becomes an exemplary impedance compensator 130. Therefore, this exemplary impedance compensator network 130 may be constructed out of a coaxial cable and include a L-C-R reactive network connected to the auxiliary transmission line 115. Thus, the compensator 130 may be capable of compensating the frequency response of the exemplary slotted antenna 120.

According to the exemplary embodiments of the present invention, the slot antenna 120 may also feature a means for providing the antenna 120 with multiple auxiliary transmission line impedance compensators, similar to the auxiliary transmission line 115 and the compensator network 130. These means may be, for example, a looped or baluned transmission line 110 combined with a number of frequency compensators, where each of the frequency compensator may appear similar to the compensator network 130. Accordingly, the motivation for multiple compensator assemblies may be to achieve a greater bandwidth over which the S11, or VSWR, is below a desired magnitude. The additional compensators may be used to accommodate the additional reactances that may be present in the more complete equivalent circuit of the slot antenna 120.

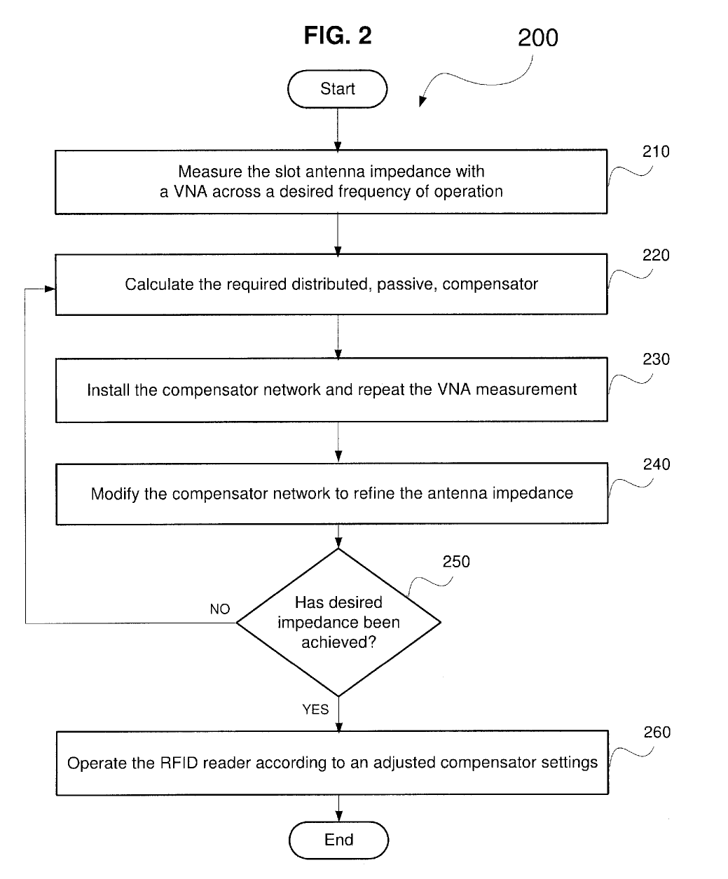

FIG. 2 represents an exemplary method 200 for compensating a frequency response of a slot antenna 120 of an electronic device, such as the RFID reader 100 according to the exemplary embodiments of the present invention. The exemplary system 200 will be described with reference to the exemplary RFID reader 100 of FIGS. 1A and 1B. The electronic device may include the RF controller 103, the PA 105, and the battery 107. Furthermore, the RFID reader 100 may include a housing such as the conductive plate, wherein the conductive plate includes the slot antenna 120. Accordingly, as described above, the exemplary slot antenna 120 may include an extremely broad loop for tracking a main resonator over a range of frequencies.

The method 200 involves determining a frequency response measurement of the slot antenna 120 and adjusting an operating setting based on the determined frequency response in order to compensate the frequency response of the slot antenna 120. As described above, the adjusted operating setting may include setting the output power level, or attenuation level, of output signal from the slot antenna 120. Accordingly, the selection of output power may allow the RFID reader 100 to vary the operation of the slot antenna 120. Furthermore, the actual settings for the output power selection, and any other adjustable conditions, may depend on the specifics of the individual RFID reader 100.

In step 210, the method 200 may measure the impedance of the slot antenna 120. Specifically, the impedance may be measured with a vector network analyzer (“VNA”) across a desired frequency of operation.

In step 220, the method 200 may calculate a required distributed, passive, compensator such as the impedance-compensating network 130 constructed out of a coaxial cable.

According to an exemplary embodiment of the present invention, the compensator 130 (e.g., the transmission line 115 with an L-C-R network 135 as the terminus) may be placed in direct contact with the slot antenna 120 in order to affect its frequency response. For instance, the compensator 130 may be held in place within the RFID reader 100 via an attaching means, such as soldering attachments, clips, clamps, jumpers, etc.

According to a further embodiment, the slot antenna 120 may be fed back upon itself, thereby creating a loop or a coil in the auxiliary transmission line 115. It should be noted that the compensator 130 may be described as a separate component from the slot antenna 120; however, according to additional embodiments of the present invention, the slot antenna 120, itself may act as the compensator 130. Accordingly, the loop 115 may allow the slot antenna 120 to self-compensate. Furthermore, the auxiliary transmission line 115 may reduce the size of the slot antenna 120, thereby providing the antenna 120 with greater mechanical integrity.

In step 230, the method 200 may install the compensator network and repeat the VNA measurement, as described in step 210.

In step 240, the method 200 may modify the compensator network in order to refine the impedance of the slot antenna 120. As described above, the compensator 130 may be used to compensate the frequency response of the slot antenna 120. The compensated frequency response may allow for both greater performance of the slot antenna 120 (e.g., greater bandwidth, improved RFID efficiency, etc.), as well as a small-implemented size for the slot antenna 120.

In step 250, the method 200 may determine whether a desired impedance has been achieved. If the desired impedance has not been achieved, the method 200 may return to step 220 and repeat steps 220 through 240. However, if the desired impedance is achieved, the method 200 may advance to step 260.

In step 260, the method 200 may operate the RFID reader 100 according to the adjusted compensator settings. As described above, these conditions may determine RFID performance characteristics, such as bandwidth and efficiency, as the RFID reader 100 communicates with RFID tags within an operating field. The specific operating settings may be fully adjustable by a user and may be implemented through the use of custom software for automatic configuration or through manual intervention by the user.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A communication device, comprising:
at least one radio frequency (“RF”) source for transmitting RF signals;
at least one RF receiver for receiving RF signals;
an antenna in simultaneous communication with the RF source and the RF receiver; and
at least one distributed RF compensator network controlling an operating RF between the antenna and the communication device, wherein the at least one distributed RF compensator creates a particular antenna impedance that operates with a directional coupler and increases an RF isolation between the RF source and the RF receiver across a particular frequency region.

2. The communication device according to claim 1, wherein the antenna is at least one of a slot dipole antenna and a cross polarized slot dipole antenna.

3. The communication device according to claim 1, wherein the antenna includes at least one of a coiled transmission line of a specific length and one or more L-C-R networks in order to allow for self-compensation.

4. The communication device according to claim 1, further comprising:
a compensator affixed to the antenna, wherein the compensator compensates the frequency response of the antenna based on at least one operating frequency range as determined by the RF controller.

5. The communication device according to claim 1, wherein the at least one distributed RF compensator includes a transmission line of a specific length and at least one L-C-R network.

6. The communication device according to claim 1, wherein the RF source transmits the RF signal to at least one target within an operating field and the antenna receives a data signal from the at least one target

7. The communication device according to claim 6, wherein the communication device is a radio frequency identification reader, and the at least one target is a radio frequency identification tag.

8. A method, comprising:
determining a frequency response impedance measurement of an antenna of a communication device, the communication device including a compensator network attached to the antenna; and
adjusting at least one operating setting of the compensator network to create a antenna impedance, wherein the antenna impedance improves an isolation between a transmitting function and a receiving function of the communication device.

9. The method according to claim 8, wherein the antenna is at least one of a slot dipole antenna and a cross polarized slot dipole antenna.

10. The method according to claim 8, wherein the communication device includes at least one radio frequency (“RF”) source transmitting an RF signal to at least one target within an operating field and receiving a data signal from the at least one target, and the communication device further includes an RF controller adjusting an operating frequency of the communication device.

11. The method according to claim 8, wherein the antenna includes at least one of a coiled transmission line of a specific length and one or more L-C-R networks in order to allow for self-compensation.

12. The method according to claim 8, wherein the communication device further includes a compensator affixed to the antenna, wherein the compensator compensates the frequency response of the antenna based on the one or more frequency settings from the RF controller.

13. A system, comprising:
a measuring means for determining a frequency response impedance measurement of an antenna of a communication device, the communication device including a compensator network attached to the antenna; and
a compensating means for adjusting at least one operating setting of the compensator network to create a antenna impedance, wherein the antenna impedance improves an isolation between a transmitting function and a receiving function of the communication device.

14. The system according to claim 13, wherein the antenna is at least one of a slot dipole antenna and a cross polarized slot dipole antenna.

15. The system according to claim 13, wherein the communication device includes at least one radio frequency (“RF”) source transmitting an RF signal to at least one target within an operating field and receiving a data signal from the at least one target, and the communication device further includes an RF controller adjusting an operating frequency of the communication device.

16. The system according to claim 13, wherein the antenna includes at least one of a coiled transmission line of a specific length and one or more L-C-R networks in order to allow for self-compensation.

17. The system according to claim 13, wherein the communication device further includes a compensator affixed to the antenna, wherein the compensator compensates the frequency response of the antenna based on the one or more frequency settings from the RF controller.
